(19) United States
(12) Patent Application Publication
(10) Pub. No.: US 2007/0042748 A1
(43) Pub. Date: Feb. 22, 2007

(54) Systems and methods for facilitating queue participation and management

(76) Inventor: Bruce B. MacArthur, Lehi, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/480,082

(22) Filed: Jun. 30, 2006

Related U.S. Application Data
(63) Continuation of application No. 60/696,477, filed on Jul. 2, 2005.

(51) Int. Cl. H04Q 7/20; H04M 11/00

(52) U.S. Cl. 455/403

(57) ABSTRACT

The invention relates to, systems and methods that may be used to facilitate customer participation in queues by allowing them to view queue wait times of several establishments at once and leave designated waiting areas. Additionally, establishments can use the described systems and methods to manage/monitor queues, improve service, and otherwise please customers. In some aspects, the systems may include a host server that may, among other things, receive, communicate, store, monitor, and manage information about customers, queues, reservations, establishments, and the like. The systems may also include a communications network and communication devices. The network may communicate information between the host server, establishment hosts, customers, and others. The communication devices may send information from customers in a remote location to the host server via a network. Additionally, the communications device can receive information.

### RELATED APPLICATIONS

This application claims priority of the U.S. Provisional Application No. 60/696477, the entire disclosures of which are incorporated herein by reference.

### FIELD OF THE INVENTION

This application relates generally to systems and methods for facilitating queue participation and management. In particular, this application relates to systems and methods for notifying customers of queue waiting times at several establishments, receiving information from customers, placing customers in queue, keeping customers apprised of queue status, and storing/tracking customer histories.

### BACKGROUND

Often, a customer (i.e., any person, paying or non-paying) may desire to go to a restaurant, theater, amusement park ride, or other establishment (i.e., any place where the customer may have to wait for an activity or to be attended), but does not want to waste time standing in queue. In order to determine wait times for various activities and avoid wasting time in queue, a customer may need to call ahead, drive by, enter in, or otherwise contact an establishment. This process can be time consuming and frustrating. Once a customer decides on an establishment to visit, the customer typically enters the establishment, provides information to a host, or takes a number, and waits in a designated area or line until the customer is attended. Typically, when a customer can be attended, the host calls the customer's name (either by voice or public-address system) or actuates an electronic device provided to the customer by the establishment.

Nevertheless, there are times when it may be difficult for an establishment to determine wait times or when the wait times will be significant (e.g., one hour). During these times, the customer may prefer to engage in another activity (e.g., shopping) besides waiting in the designated area. However, under current practices, the customer generally must remain within hearing range of the host or within signal range of the electronic alerting device. If a customer leaves those ranges, the customer risks losing placement in the queue.

### SUMMARY

This invention relates to systems and methods that may facilitate customer participation in queues by allowing them to view queue wait times of several establishments at once. In some embodiments, establishments can use the described systems and methods to manage/monitor queues, improve service, and otherwise please customers. In some embodiments, the systems may include a host server that may, among other things, receive, communicate, store, monitor, and manage information about customers, queues, reservations, establishments, and the like. Some embodiments may also include a communications network and communication devices. In some embodiments, the network may communicate information between the host server, establishment hosts, customers, and others. The communication devices may send information from customers in a remote location to the host server via a network. Additionally, the communications device can receive information from the host server.

### BRIEF DESCRIPTION OF THE DRAWINGS

The following description can be better understood in light of the Figures, in which:

FIG. 1 depicts a block diagram representing non-limiting example of a system for facilitating queue participation and management;

FIG. 2 illustrates an exemplary screenshot of a non-limiting example of a queue management web page operated by a host server included within the system of FIG. 1; and

FIG. 3 contains a flow diagram of a non-limiting example of a method for facilitating queue management and participation.

### DETAILED DESCRIPTION

The detailed description of exemplary embodiments of the invention herein makes reference to the accompanying drawings and screenshots. While these exemplary embodiments are described in sufficient detail to enable those skilled in the art to practice the invention, it should be understood that other embodiments may be realized, and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, functional embodiments of apparatus and systems (and components of the individual operating components of the apparatus and systems) may not be described in detail herein. Furthermore, the connecting lines shown in the various Figures contained herein are intended to represent exemplary functional relationships and/or physical connections between the various elements. It should be noted that many alternative or additional functional relationships or physical connections may be present in a practical system. Additionally, while the invention is described for use with queue participation and management in establishments, such as restaurants, it could be used for many purposes and with any establishment that requires customers to wait before an activity or before being attended. Some additional examples of such establishments are salons, pharmacies, golf courses, doctor's office, dental office, departments of motor vehicles, and so forth.

The systems can facilitate queue participation and management by allowing customers to communicate information with establishments from remote locations. For example, establishments can send a list of queue wait times to customers, the customers can choose an establishment from the list, and the customers can then send a reservation confirmation to the selected establishment. Accordingly, some embodiments of the systems may comprise of a first device in a first location where the information is stored, a second device in a second location for communicating to and receiving information from the first device, a third device in a third location for communicating to and receiving information from the first device, and means for communicating between all of the devices.

Some embodiments comprise the ability to track a package being delivered to your home via FedEx, UPS, USPS, and/or other courier service. In some embodiments this allows a customer or service provider to be given information about the status of a package. In some embodiment this allows a customer or service provider to be given more accurate information about the estimated time of arrival for a given package or item being delivered. In some embodiments a customer may track the estimated time of arrival of an item with a mobile device. The device may be any mobile device. In a non-limiting example the mobile device may be a mobile phone or PDA. In some embodiments the customer my receive an alert apprising them that the item being delivered will arrive within a given amount of time allowing the customer to be at the delivery point during the time frame when the object is delivered to ensure delivery.

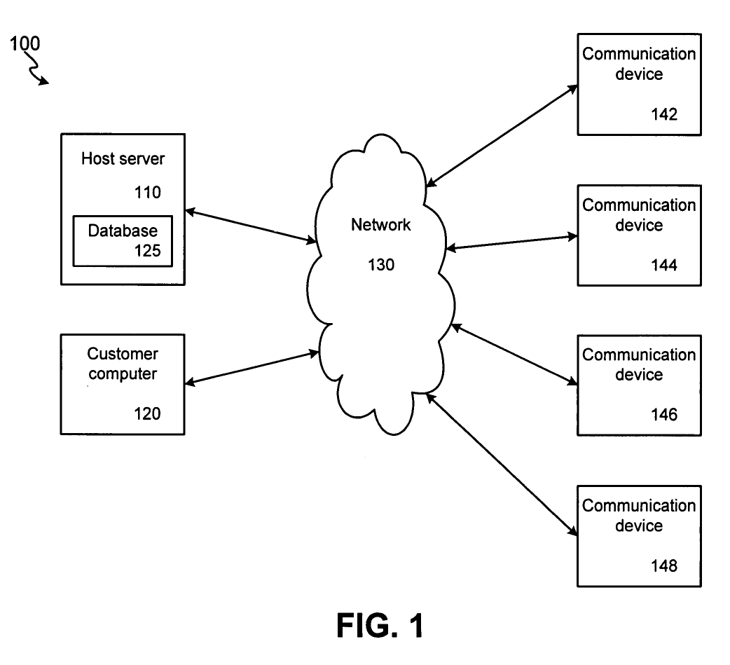

FIG. 1 illustrates a block diagram of one embodiment of a system 100 that may facilitate queue participation and management. As that figure depicts, some embodiments of the system 100 may contain a first device (i.e., host server 110) located in a first location. The first location can be located anywhere desired by the host server operator. For example, the first location may be an establishment, such as a restaurant, in a central location (with central not referring to geographic location). The first device may act as a repository for information. Any device that can operate as a repository can function as the first device.

One example of the first device comprises a host server 110, which may include a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; a plurality of databases (e.g., database 125); and so forth.

The host server 110 can perform any function. In accordance with one exemplary embodiment, the host server 110 is suitably configured to receive and store any information sent from a customer (“customer information”). This customer information may include, among other things, personal information (e.g., name, telephone number, e-mail address, credit/charge/debit card information, and the like), reservation information (e.g., establishment selected, time, date, party size, special needs, etc.), and any other information/functions suitable for taking a reservation and/or forming a queue. The host server 110 may also create reservations, form queues, and otherwise monitor/manage queues. Additionally, the host server 110 can send any information to the other devices of system 100 (i.e., customer computer 120 and communication devices 142, 144, 146, and 148). Such information may include establishment information (e.g., queue wait times, confirmation information, updated queue status reports, advertising, messages, menus, discounts, and so forth), customer information, and any other information useful for the operation of the system 100.

In some aspects, multiple host servers 110 may be connected together to make a host server cluster. Using a host server cluster may permit sharing information regarding the customers, establishments, queues, and other information host server 110 has recorded. By using a server cluster, the system 100 may also always be operational, regardless of the location of a particular component on the network that connects the components (such as the Internet). The server cluster can contain a primary cluster, which handles all critical tasks, with minor functions being routed to a secondary cluster. With this configuration, if the primary cluster is not operational, most functions can be handled by the secondary cluster. A server cluster also may allow a large-scale deployment and interoperability, as well as allow information to be stored on the network in multiple points of co-location.

As stated, host server 110 may also comprise database 125. Database 125 may be any device and/or components suitably configured to store information/data. As such, database 125 may be any database known in the art or later developed. In one exemplary embodiment, database 125 may store customer information; establishment information; and/or similar data useful in the operation of system 100. In another exemplary embodiment, database 125 may store history data related to the customer. For example, the customer information may also include data related to the number of “no shows”, amount spent, number of visits, and/or any other data deemed valuable to the establishment or entity operating system 100.

Furthermore, database 125 may include relational, hierarchical, graphical, or object-oriented structure and/or any other database configurations. Common database products that may be used to implement database 125 include DB2 by IBM (White Plains, N.Y.), various database products available from Oracle Corporation (Redwood Shores, Calif.) Microsoft Access or Microsoft SQL Server by Microsoft Corporation (Redmond, Wash.), or any other suitable database product. Moreover, database 125 may be organized in any suitable manner. For example, the database may be organized as data tables or lookup tables. Also, each record may be a single file, a series of files, a linked series of data fields, or any other data structure.

Association of certain data may be accomplished through any desired data association technique known or practiced in the art. For example, the association may be accomplished either manually or automatically. Some examples of automatic association techniques may include a database search, a database merge, GREP, AGREP, SQL, the use of one or more key fields in the tables to speed searches, sequential searches through all the tables and files, the sorting of records in the file according to a known order to simplify lookup, and/or the like. The association step may also be accomplished by a database merge function, for example, using a key field in pre-selected data sectors.

More particularly, a key field partitions database 125 according to the high-level class of objects defined by the key field can be used. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using any known linking means, such as AGREP.

In accordance with some embodiments, any suitable data storage technique may be utilized to store data without a standard format. Data sets may be stored using any suitable technique, including storing individual files using an ISO/IEC 7816-4 file structure; implementing a domain whereby a dedicated file is selected that exposes one or more elementary files containing one or more data sets; using data sets stored in individual files using a hierarchical filing system; using data sets stored as records in a single file (including compression, SQL accessible, hashed via one or more keys, numeric, alphabetical by first tuple, etc.); implementing Binary Large Object (BLOB); storing as ungrouped data elements encoded using ISO/IEC 7816-6 data elements; storing as ungrouped data elements encoded using ISO/IEC Abstract Syntax Notation (ASN.1) as in ISO/IEC 8824 and 8825; and/or employing other proprietary techniques that may include fractal compression methods, image compression methods, etc.

In some embodiments, the data, including the header or trailer, may be received by a stand-alone interaction device configured to add, delete, modify, or augment the data in accordance with the header or trailer. As such, in one embodiment, the header or trailer is not stored on the transaction device along with the associated issuer-owned data, but instead the appropriate action may be taken by providing the transaction device user at the stand-alone device with the appropriate option for the action to be taken. In some embodiments, system 100 may comprise a data storage arrangement wherein the header or trailer, or header or trailer history, of the data is stored on the transaction device in relation to the appropriate data.

As used herein, the term “transmit” may include sending electronic data from one system component to another over a network connection. Additionally, as used herein, “data” may include encompassing information such as commands, queries, files, data for storage, and the like in digital or any other form.

In some embodiments, host server 110 may provide a suitable website or other Internet-based graphical user interface suitably configured to take reservations from a customer. Any known Internet-based graphical user interface can be used for this purpose. For example, in one embodiment, a Microsoft Internet Information Server (IIS), Microsoft Transaction Server (MTS), and Microsoft SQL Server, are used in conjunction with a Microsoft operating system, Microsoft NT web server software, a Microsoft SQL Server database system, and a Microsoft Commerce Server. Additionally, components and software, such as Access or Microsoft SQL Server, Oracle, Sybase, Informix MySQL, Interbase, etc., may be used to provide an Active Data Object (ADO) compliant database management system.

In some embodiments, any of the communications, inputs, storage, databases, or displays discussed herein may be facilitated through the website, which may include one or more web pages. The term “web page” as it is used herein is not meant to limit the type of documents and applications that might be used to interact with the user. For example, a typical website might include, in addition to standard HTML documents, Java applets, various forms, JavaScript, active server pages (ASP), common gateway interface scripts (CGI), extensible markup language (XML), dynamic HTML, cascading style sheets (CSS), helper applications, plug-ins, and the like.

A web server may also include a web service that can receive requests from a web server, the request including a URL (e.g., http://yahoo.com/stockquotes/ge) and an IP address (e.g., 123.56.789.234). The web server may retrieve the appropriate web pages and send the data or applications for the web pages to the IP address. Web services are applications that are capable of interacting with other applications over a communications means, such as the Internet. Web services are typically based on standards or protocols, such as XML, SOAP, WSDL, UDDI, and the like. Web services methods are well known in the art and are covered in many standard texts. See, for example, ALEX NGHIEM, IT WEB SERVICES: A ROADMAP FOR THE ENTERPRISE (2003), which is hereby incorporated by reference.

Some embodiments utilize alternative methods for displaying data within a browser-based document. Data may be represented in practically any way, including as standard text, or as text or images within a fixed list, scrollable list, drop-down list, editable text field, fixed text field, pop-up window, and the like. Likewise, there are a number of methods available for modifying data in a web page. For example, data in a web page could be modified with free text entry using a keyboard, selection of menu items, check boxes, option boxes, and so forth.

As described above, some embodiments of the systems may also comprise a second device that can be located in a second location that is optionally remote from the first location. The second device may transfer information to and receive information from the first device (i.e., host server 110). Any device operating in this manner can be used as the second device. In some aspects, the second device comprises customer computer 120.

FIG. 1 depicts that the system 100 may also contain one or more customer computers 120 that allow customers to send information (i.e., customer information) to host server 110 of one or more establishments and receive information from one or more host servers (i.e., establishment information, such as queue waiting times). Customer computer 120 may comprise any suitable personal computer, network computer, workstation, minicomputer, mainframe, or the like. Some examples of customer computer 120 include laptops, notebooks, hand-held computers, set-top boxes, cellular telephones, touch-tone telephones, and the like. Customer computer 120 may be in any environment, including that of a home or business with access to communications means (i.e., network 130, as described below). In an exemplary embodiment, customer computer 120 may have access to the website through network 130 or the Internet via a commercially-available web-browser software package. Further, customer computer 120 may have access to the website via network 130. For example, a customer at home could use customer computer 120 to access the website and check queue times at various establishments.

In some embodiments, customer computer 120 may also include any conventional operating system, as well as various conventional support software and drivers typically associated with computers. For example, customer computer 120 may include Windows NT, 95/98/2000, OS2, UNIX, Linux, Solaris, MacOS, and so forth.

FIG. 1 illustrates some embodiments of the systems which may also comprise a third device that communicates information to, and receives information from, the first device (i.e., host server 110). Any device that can perform this function can be used. In one embodiment, the third device of system 100 may comprise one or more customer communication devices (e.g., communication device 142, communication device 144, and/or communication device 146) that may communicate with host server 110 via communications means (i.e., network 130). Communication devices 142, 144, and 146 may be any device and/or components suitably configured to communicate with (e.g., receive a signal from) host server 110 via network 130. As such, communication devices 142, 144, and 146 may be any communication device known in the art or later developed. In one exemplary embodiment, communication devices 142, 144, and 146 may each be a cellular telephone, a Blackberry, a PDA, a pager, touch screen terminal, or the like.

Host server 110 may be suitably configured to communicate with each of communication devices 142, 144, and 146, wherein each of communication devices 142, 144, and 146 is a different type of communication device. For example, communication device 142 may be a cellular telephone, whereas communication device 144 may be a Blackberry, and communication device 146 may be pager.

In some embodiments, host server 110 may be configured to transmit any information to communication device 142. For example, host server 110 could send a Short Message Service (SMS) message to communication device 142 to inform the customer of queue times at various establishments. In another example, after the customer selected an establishment and entered the queue from a remote location, the host server 110 could transmit a SMS to the customer, and thereby could alert the customer of queue status (e.g., “Five minutes until you will be seated.”).

As mentioned, some embodiments of the system may contain means for communicating between the various devices. Any conventional communications means can be for this purpose. For example, FIG. 1 illustrates that network 130 may be used. In some embodiments, network 130 may include any electronic communications means that may incorporate both hardware and/or software components and may allow communication among the devices (e.g., host server 110, customer computer 120, customer communication devices 142, etc.). This communication may be accomplished through any suitable communication channels, such as land-based or cellular telephone networks, extranets, intranets, Internet, online communications, satellite communications, microwave communications, frame relays, Ethernet, DSL, off-line communications, wireless communications (e.g., Wi-Fi communications), transponder communications, local area networks (LAN), wide area networks (WAN), networked or linked devices, keyboard, mouse, touch screen, and/or any other suitable communication or data input modality. Moreover, system 100 may be implemented with TCP/IP communications protocols, using IPX, Appletalk, IP-6, NetBIOS, OSI, or any number of existing or future protocols.

In some embodiments, the network may be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

In some embodiments, the various components of system 100 may be independently, separately, or collectively connected to network 130 via data links. These links may include, for example, a connection to an Internet Service Provider (ISP) over the local loop as is typically used in connection with standard modem communication, cable modem, Dish networks, ISDN, Digital Subscriber Line (DSL), various wireless communication methods, or any other form of data link. See, for example, GILBERT HELD, UNDERSTANDING DATA COMMUNICATIONS (1996), which is hereby incorporated by reference. Notably, network 130 may be implemented as any other type of network, such as an interactive television (ITV) network. Moreover, system 100 contemplates the use of services or any network having similar functionality described herein for the transmission of information.

In some embodiments, databases, systems, devices, servers, or other components of system 100 may consist of any combination thereof at a single location or at multiple locations. Each database or system may also include any suitable security feature, such as firewalls, access codes, encryption, decryption, compression, decompression, and/or combinations thereof.

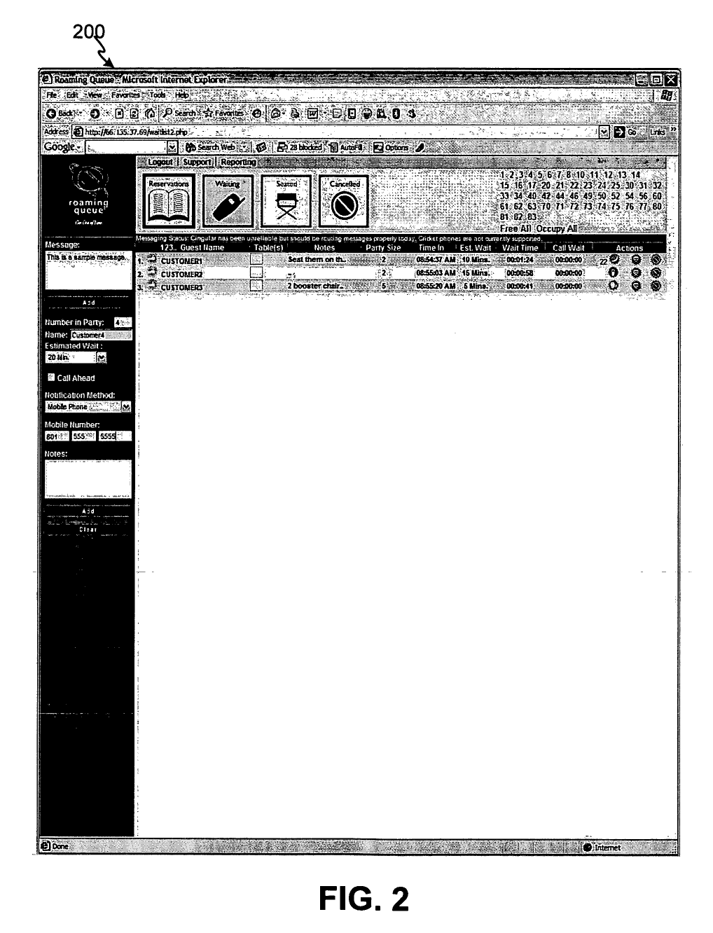

FIG. 2 illustrates a non-limiting example of a screenshot of one embodiment of a queue management web page 200 (“web page 200”) operated by host server 110. In one exemplary embodiment, web page 200 provides a list of customers and the order in which the customers are to be seated as tables become available. Furthermore, some embodiments of web page 200 may include objects to identify the stage of each customer during the process. For example, there may be a field in which the customer may be identified as “waiting”, “seated”, or “cancelled”. Moreover, some embodiments of web page 200 may include fields for showing the customer party size, time in, time out, estimated wait time, actual wait time, call wait, notes, special needs (e.g., wheelchair access, allergies, highchair, etc.), and/or any other field which may include information deemed important to the entity/establishment operating web page 200.

FIG. 3 depicts a method of one embodiment, and is not intended to limit the scope of the invention as described herein. For example, the steps recited may be executed in any order and are not limited to the order presented. It will be appreciated that the following description makes appropriate references not only to the steps and user interface elements depicted in FIG. 3, but also to various components of system 100 as described above with reference to FIG. 1.

FIG. 3 illustrates a flow diagram of an embodiment of a method 300 for facilitating queue management and participation. In accordance with one exemplary embodiment of the invention, method 300 initiates by programming a host server (e.g., host server 110) to gather, receive, and or share any information from one or more establishments via host servers 110, the webpage, network 130 and or other devices (i.e., customer computer 120 and communication device 142). The host server 110 may receive any type of information from any establishment. For example, the host server may receive establishment information, including queue times, menus, advertisements, messages, discounts, and the like (step 301).

Step 305 illustrates that host server 110 may in some embodiments then send such information (e.g., establishment information) to one or more customers. For example, host server 110 may send this information to customers located anywhere in the world via network 130, customer computer 120, and/or communication device 142. In this example, a customer may use communication device 142 and select “restaurants”, for example, from the establishments listed on a menu displayed on the communication device 142. The customer could further narrow the selection by choosing restaurants by theme, location, or any other desired criteria. The customer may then receive a list of all of the queue times for the selected categories and choose the restaurant with the shortest queue. In another example, a customer may use communication device 142 and may select an option that allows the customer to check queue times at all of the Mexican restaurants in the local vicinity. In yet another example, a customer may use communication device 142 to check queue wait times at various tire shops located throughout a large city and use that information to plan errands.

A host server may also be programmed to receive any information from the customer (e.g., customer information, discussed above) (step 310). This information may be sent to the host server 110 using any means, including customer computer 120, communications device 142, a web page, or an employee of the operator of the host server 110, via network 130.

In some embodiments, method 300 may comprise a host server 110 receiving the customer information from the customer on a web page operated by host server 110, which the customer may have accessed using a computer (e.g., customer computer 120) via a network (e.g., network 130). In some embodiments, method 300 may comprise host server 110 receiving customer information and establishment information from an employee of the establishment operating host server 110 via, for example, a keyboard and/or mouse. In yet another embodiment, host server 110 may receive information from the customer via communications device 142.

In some embodiments, method 300 is comprised of programming host server 110 to place the customer in a queue once the customer's information is received (step 320). In another embodiment, method 300 includes programming host computer 110 to monitor and appropriately manage the queue (step 330). For example, host computer 110 is programmed to delete customers from the queue once they have been attended, properly move customers up as customers are deleted, and add new customers to the end of the queue.

In some embodiments, method 300 may include programming host server 100 to alert a customer, via the customer's communication device (e.g., communication device 142), with updated queue status reports (e.g., that the customer is nearing the front of the queue) (step 340). In some embodiments, host server 110 is programmed to alert the customer at a pre-determined time (e.g., ten minutes) prior to the estimated time that the customer will be in the front of the queue. In some embodiments, host server 110 is programmed to alert the customer that there are a pre-determine number of customers (e.g., two) in front of the customer. In some embodiments, method 300 includes programming host server 110 to alert the customer, via communication device 142, that the customer is at the front of the queue and will now be attended (step 350).

The customer may be alerted utilizing any means or method known in the art. Some examples of such means and methods include a text message, a picture, a video message, an audible noise, a vibration, a voice message, a telephone call, and/or any other method capable of being transmitted by communication device 142.

In some embodiments, method 300 may include programming host server 110 to store and track the customer's history similar to the embodiments of the customer's history discussed above (step 360). In this way, an establishment can better manage queues by having reliable feedback that can be used to better estimate waiting time and the needs of customers.

In some embodiments, the steps discussed above with reference to FIG. 3 may be embodied as computer program instructions capable of being loaded onto any programmable data processing apparatus to produce machine-readable instructions. Some examples of programmable data processing devices include general purpose computers and special purpose computers. These computer program instructions, when executed on the computer or other programmable data processing apparatus, create a means for implementing the functions specified in the flow diagram block or blocks. Furthermore, these computer program instructions may also be stored on a computer-readable memory that can direct a computer or other programmable data processing apparatus to function in a particular manner. In this way, the instructions stored in the computer-readable memory may produce an article of manufacture, including instruction means that may implement the function specified in the flow diagram block or blocks. The computer program instructions may also be loaded onto a computer or other programmable data processing apparatus to cause a series of operational steps to be performed on the computer or other programmable apparatus that produce a computer-implemented process. In this manner, the instructions, which execute on the computer or other programmable apparatus, provide steps for implementing the functions specified in the flow diagram block or blocks.

Functional blocks of the block diagrams and flow diagram illustrations support combinations of means for performing the specified functions, combinations of steps for performing the specified functions, and program instruction means for performing the specified functions. It will also be understood that each functional block of the block diagrams and flow diagram illustrations, and combinations of functional blocks in the block diagrams and flow diagram illustrations, can be implemented by either special purpose hardware-based computer systems, which may perform the specified functions or steps, or suitable combinations of special purpose hardware and computer instructions. Further, illustrations of the process flows and the descriptions thereof may make reference to web pages, websites, etc.

The illustrated steps described herein may comprise any number of configurations, including the use of windows, web pages, web forms, popup windows, prompts, and the like. The multiple steps, as illustrated and described, may be combined into single web pages and/or windows but may have been expanded herein for the sake of simplicity. In other cases, steps illustrated and described as single process steps may be separated into multiple web pages and/or windows but may have been combined herein for simplicity.

System 100, screenshot 200, and method 300 are described herein in terms of functional block components, screenshots, optional selections, and various processing steps. Such functional blocks may be realized by any number of hardware and/or software components configured to perform the specified functions. For example, system 100 may employ various integrated circuit components, (e.g., memory elements, processing elements, logic elements, look-up tables, and the like). Each of these integrated circuit components may carry out a variety of functions under the control of one or more microprocessors or other control devices.

Similarly, the software elements of system 100 may be implemented with any known programming or scripting language. Some examples of programming and scripting language include C, C++, Macromedia Cold Fusion, Microsoft Active Server Pages, Java, COBOL, assembler, PERL, Visual Basic, SQL Stored Procedures, extensible markup language (XML), and the like. Each of the foregoing examples of programming and/or scripting language may also be used with the various algorithms being implemented with any combination of data structures, objects, processes, routines, and/or other programming elements. Further, it should be noted that system 100 may employ any number of conventional techniques for data transmission, signaling, data processing, network control, and the like.

Still further, system 100 could be used to detect or prevent security issues with any known customer-side scripting language, such as JavaScript, VBScript, or the like. For a basic introduction of cryptography and network security, see any of the following references: (1) “Applied Cryptography: Protocols, Algorithms, and Source Code in C,” by Bruce Schneier, published by John Wiley & Sons (second edition, 1995); (2) “Java Cryptography” by Jonathan Knudson, published by O'Reilly & Associates (1998); and (3) “Cryptography & Network Security: Principles & Practice” by William Stallings, published by Prentice Hall; all of which are hereby incorporated by reference.

As will be appreciated by one of ordinary skill in the art, system 100 may be embodied as a customization of an existing system, an add-on product, a software upgrade, a stand-alone system, a distributed system, a method, a data processing system, a device for data processing, and/or a computer program product. Accordingly, system 100 may be embodied entirely as software, entirely as hardware, or may have an embodiment combining aspects of both software and hardware. Furthermore, system 100 may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

System 100, screenshot 200, and method 300 are described herein with reference to screenshots, block diagrams and flow diagram illustrations of methods, apparatus (e.g., systems), and computer program products according to various embodiments. It will be understood that each functional block of the block diagrams and the flow diagram illustrations, and combinations of functional blocks in the block diagrams and flow diagram illustrations, respectively, can be implemented by computer program instructions.

The systems and methods described above may present several benefits and may facilitate queue participation and management in any number of ways. Additionally, the systems of the present invention provide the ability to remote update the software from the host server to any of the other devices in the system. The systems and methods may allow for queue participation by allowing, among other things, customers to receive information from several establishments, view and compare queue times of several establishments at once, reserve a place in queue, send information to an establishment, and/or be appraised of queue status from remote locations. In this way, a customer may avoid wasting time waiting in queue and/or designated waiting areas, while still participating in the queue. In one example of how queue participation can be facilitated, a customer who is in a hurry before a movie may check queue times at several restaurants in the area and choose the restaurant with the shortest queue. In another example, a customer who orders takeout may receive an alert message on the customers PDA when the food is ready. In this way, the customer can spend as little time as desired in the restaurant.

The systems and methods described may also allow for facilitation of queue management in any variety of ways. Particularly, the described systems and methods may allow establishments to manage queues by, among other things, sending queue status information to one or more customers, receiving customer/reservation information, creating queues, monitor queues, sending updates of queue status, sending notification information to customers, storing and tracking customer information, and the like.

Using these systems and methods for queue management, establishments can also be more efficient. For example, establishments that use these systems and methods can better keep accurate table inventories that can be used to speed seating. Additionally, with accurate table inventories and queue lists, establishments can better handle last minute changes or cancellations and quickly notify customers further down in the queue of openings and/or advances in the queue.

The systems and methods may also allow establishments to have continuous access to relevant data that can be used to identify problematic trends, customer needs/desires, and for better decision making. For example, customer and establishment information, among other things, may be monitored and/or reported to host server operators and/or third parties. This data can be monitored in any way. For instance, because the systems may contain host server 110 and the website, host server operators or third parties may access information directly from the host server or via the website. In this way, monitoring can be accomplished both on-site and from remote locations. This monitoring can also be accomplished in real-time (or in near real-time, due to imperfect data transmission speeds) or as desired.

These systems and methods may also facilitate establishments in queue management by keeping customers happier. This may be accomplished by allowing customers remotely choose establishments with shorter queues. Additionally, the systems and methods allow customers to roam outside of designated areas while waiting in queue. By doing this, establishments may grant customers a sense of freedom, order, and fairness. Waiting rooms may be emptier, quieter, and more organized. Parking lots may also be emptier. Additionally, establishments can use the data gathered to customize the queue management for individuals and/or groups of customers. For example, an establishment could review average dining times for a particular customers and thereby better estimate table availability when those particular customers are present. In another example, an establishment could monitor a customer's habits and use that information to customize advertising to that person. In this example, an establishment may send advertisements (e.g., text messages, discounts, wallpapers, popup ads, etc.) for a Mexican restaurant to a customer who habitually patronizes Mexican restaurants.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device, system, or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. § 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

I claim:

1. A computer-implemented method for facilitating queue participation for customers, comprising the steps of:
receiving establishment information from a host server;
allowing a customer to select an establishment from the establishment information;
sending customer information to the host server;
receiving confirmation of selection from host server; and
receiving updated reports regarding the establishment information.

2. The method of claim 1, wherein the establishment information comprises queue waiting times for several establishments.

3. The method of claim 1, wherein the establishment information further comprises information selected from a list consisting of queue status reports, advertising, and messages.

4. The method of claim 1, wherein the selected establishment is chosen from a menu.

5. The method of claim 1, wherein the selected establishment is a place where a customer waits.

6. The method of claim 1, wherein the selected establishment is a restaurant.

7. The method of claim .1, wherein the establishment information and customer information is received from and sent to a remote location.

8. The method of claim 1, wherein the establishment information is received by a communication device.

9. The method of claim 7, wherein the communication device comprises a device suitably configured to receive a signal from the host server.

10. The method of claim 8 where in the communication device is selected from a list consisting of a cellular telephone, a personal digital assistant, a Blackberry, a hand-held computer, and a computer.

11. The method of claim 1, wherein the establishment information is received by a customer computer.

12. A method for facilitating queue management for establishments, comprising the steps of:
gathering establishment information from one or more establishments;
sending the establishment information to customer;
receiving customer information;
sending confirmation of customer selection to customer; and
sending updated reports to customer regarding establishment information.

13. The method of claim 12, further comprising the step of monitoring the system, use, and any associated information.

14. The method of claim 12, further comprising the step of sending advertising to customers.

15. The method of claim 12, further comprising the steps of tracking and storing customer information.

16. The method of claim 12, wherein the establishment information comprises queue waiting times.

17. The method of claim 12, wherein the establishment comprises a place where a customer waits.

18. The method of claim 12, wherein the establishment comprises a restaurant, golf course, a doctor's office and a dental office.

19. The method of claim 12, wherein the customer is remotely-located.

20. The method of claim 12, wherein the customer information comprises any information sent by a customer.

21. A system for facilitating queue participation and management, comprising:
a database for storing information;
a transmission device for sending queue waiting times from several establishments to customers;
a receiving device for receiving customer information; and
a transmission device for sending updated queue status reports to a customer from a plurality of establishments.

22. The system of claim 21, further comprising a device for monitoring the system.

23. The system of claim 21, further comprising a device for managing a queue.

24. The system of claim 21, further comprising a device for sending and receiving information from a customer in a remote location.

25. A computer program product for implementing within a computer system a method for facilitating queue participation and management, the computer program product comprising:
a computer readable medium for providing computer program code means utilized to implement the method, wherein the computer program code means is comprised of executable code for implementing the steps for:
gathering queue waiting times from one or more establishments;
sending the queue waiting times to a customer;
receiving customer information;
sending confirmation of customer selection to a customer; and
sending updated queue status reports to a customer.

26. A computer program product as recited in claim 25, where in the computer program code means is further comprised of executable code for implementing an additional step selected form a list consisting of:
(i) monitoring the system and associated information.
(ii) managing a queue.
(iii) sending advertising to a customer.
